(19) United States
(12) Patent Application Publication
(10) Pub. No.: US 2018/0046409 A1
(43) Pub. Date: Feb. 15, 2018

(54) MASS STORAGE DEVICES PACKAGES AND SOFTWARE-DEFINED ARRAYS OF SUCH PACKAGES

(71) Applicant: International Business Machines Corporation, Armonk, NY (US)

(72) Inventors: Soeren Bleikertz, Horgen (CH); Nikola Knezevic, Zurich (CH); Zoltan Arnold Nagy, Zurich (CH)

(21) Appl. No.: 15/232,805

(22) Filed: Aug. 10, 2016

(51) Int. Cl. G06F 3/06

(52) U.S. Cl. CPC G06F 3/0659; G06F 3/0604; G06F 3/0689

(57) ABSTRACT

A mass storage devices package includes a structure comprising a stack of two or more mass storage devices of same dimensions, each having a form factor having two opposite main surfaces. The mass storage devices are superimposed in a stacking direction perpendicular to their main surfaces. The mass storage devices package further includes a controller board mounted on top of the stack, aligned therewith, the controller board including connectors connecting to the mass storage devices of the stack so as to control the mass storage devices. The controller board has a form factor having two opposite main surfaces, the latter vis-à-vis main surfaces of the more mass storage devices of the stack, wherein a maximal dimension of any of the main surfaces of the controller board is less than or equal to a maximal dimension of the structure, in any direction perpendicular to the stacking direction.

### BACKGROUND

The invention relates generally to the field of mass storage devices packages and software-defined arrays of such packages.

Software defined storage (SDS) systems usually use commodity parts: a large chassis, CPU, memory, a network controller and commodity disks. Taken together, the prices of the components, the per-disk overhead is significant; that is, the price of the system without the disks divided by the maximum number of supported disks that the system can host is high.

For instance, for some datacenters, the low per-rack power capacity limits the possible density on conventional platforms. This, in turn, results in high capital expenditures for the system on a per disk basis, as well as in high operational expenditures due to the per-disk power usage of the components.

Another issue with SDS systems is that they typically have a high CPU utilization. For example, a system managing 72 disks may very well drive a high-end CPU to 100% utilization all the time, making the CPU the bottleneck.

In addition, SDS systems also have similar high utilization of the network interconnect. Not having enough ports could have negative consequences as network interface controller pricing is typically high.

The so-called JBOD (Just-a-Bunch-Of-Disks) systems are known, which involve only disks and disk connectors. However, such systems do, in principle, not solve the above issues, as the head node (i.e., a system that connects to the JBOD system and utilizes disks thereof) still needs to be powerful enough to handle the disks, but still potentially suffers from high power, CPU and network utilizations. Furthermore, the JBOD approach implies a reduction of the density of the system as a whole, as another chassis is necessary for the head node, in order to have a fully functional system.

Daisy chaining JBOD systems introduces an input-output (IO) bottleneck at the Serial Attached Small Computer System Interface (SAS) expander level.

### SUMMARY

According to a first aspect, the present invention is embodied as a mass storage devices package. The package comprises a structure comprising a stack of two or more mass storage devices of same dimensions. Each storage device has a form factor so as to have two opposite main surfaces. The mass storage devices are superimposed in a stacking direction perpendicular to their main surfaces. The package further comprises a controller board mounted on top of the stack, aligned therewith. The controller board comprises connectors connecting to the mass storage devices of the stack, so as to allow control of the mass storage devices via or by the controller board. The controller board too has a form factor, so as to have two opposing main surfaces, the latter opposite to (i.e., face-to-face with) main surfaces of the more mass storage devices of the stack. A maximal dimension of any of the main surfaces of the controller board is less than or equal to a maximal dimension of the structure, in any direction perpendicular to said stacking direction.

In the above package, the controller board extends essentially in a plane perpendicular to the stacking direction, i.e., parallel to the extension plane of the storage devices. The constraint otherwise imposed to the controller board, in terms of alignment and dimensions with respect to the structure of stacked storage devices, results in that the lateral footprint of the package (in a plane perpendicular to said stacking direction) is essentially determined by the structure, rather than by the controller board. That is, the controller board does not project over the contours of the structure, laterally; i.e., the controller board does not form any substantial overhang above said structure, which would otherwise impact the lateral footprint of the package. Laterally compact packages are thereby obtained, which can be paired, to form a dense arrangement.

In particular, such packages can be used as modular packages, e.g., in a software-defined array. In one or more embodiments such as described below, each package may for instance be laterally connected to one or more neighboring packages, in a software-defined array, via carrier boards thereof. This yields advantageous expansion capabilities. Moreover, partitions of a software-defined array of such packages can be flexibly configured.

In one or more embodiments, the structure further comprises a carrier board, wherein each of the mass storage devices of the stack is mounted transversally on the carrier board so as to be superimposed along said stacking direction. The carrier board eases the assembly of the stacked storage devices. Again, the lateral footprint is essentially determined by the structure, now including the carrier board.

In one or more embodiments, the carrier board further comprises second connectors, which connect the mass storage devices of the stack to the first connectors of the controller board, in order to ease connectivity of the storage devices to the controller board.

Optionally, in one or more embodiments, said second connectors are further configured to allow connection thereof to a carrier board of another mass storage devices package, such as described above. As described in further detail herein below, this makes an array of such packages easily expandable and configurable.

Preferably, the second connectors are configured to allow connection thereof to two or more carrier boards of other mass storage devices packages. For instance, the second connectors may comprise two or more PCIe computer bus interfaces. As it can be realized, configuring connectors of the carrier boards to allow direct connections to neighboring carrier boards allows to offload I/O processing from the controller board. In addition, this makes it possible to easily expand packages in a software-defined array.

Preferably, the (first) connectors of the controller board comprises a SATA host bus adapter (i.e., a SATA controller) and at least one of the mass storage devices of the stack is connected to said SATA host bus adapter, so as to be operated as flash memory by or via the controller board.

In one or more embodiments, the stack comprises at least three mass storage devices of same dimensions, each connected to host bus adapters of the (first) connectors of the controller board. The (first) connectors comprises two SATA host bus adapters and two of the mass storage devices of the stack are connected to said two SATA host bus adapters, respectively, so as to be operated as flash memory by or via the controller board.

Preferably, the stack comprises ten or more of said mass storage devices of the same dimensions, each connected to host bus adapters of said connectors of the controller board.

In one or more embodiments, the first connectors (i.e., the connectors of the controller board) comprises a first PCIe adapter and the second connectors (of the carrier board) comprises a second PCIe adapter, the latter connected to the first PCIe adapter. The carrier board further comprises: a PCIe switch, connected to the second PCIe adapter; and one or more PCIe-to-SATA converters, each connected to the PCIe switch. In addition, one or more subgroups of mass storage devices of the stack are connected, each, to said PCIe switch via a respective one of the PCIe-to-SATA converters.

Preferably, the package comprises two PCIe-to-SATA converters and two subgroups of mass storage devices, wherein each of the subgroups comprises four mass storage devices of same dimensions.

More preferably, the package comprises three PCIe-to-SATA converters and three subgroups of mass storage devices, each of the subgroups comprising four mass storage devices of same dimensions.

In one or more embodiments, the controller board comprises a processing unit. The (first) connectors of the controller board accordingly connect the processing unit to the mass storage devices of the stack.

In one or more other embodiments, the controller board is embodied as an expander board, which comprises a switch but does not necessarily comprise a processing unit. Still, the (first) connectors of the expander board connect said switch to the mass storage devices of the stack. The switch is connectable to the processing unit of a controller board of a mass storage devices package such as evoked just above. Thus, resources of the expander board can be controlled via or by another controller board, equipped with a processing unit.

According to another aspect, the invention is embodied as a software-defined array of mass storage devices packages. The array comprises two or more mass storage devices packages according to any of the above embodiments. These packages are configured as partitions of the array, wherein each of the partitions involves at least one of the packages.

In one or more embodiments, one of the mass storage devices packages is connected to another one of the packages of the array. Each mass storage devices package has a carrier board with second connectors, as described above.

Preferably, the array comprises three (or more) mass storage devices packages. Each of the packages has a carrier board whose second connectors are configured to allow connection thereof to one or more carrier boards of other mass storage devices packages of the array. Thus, one of the packages can be connected to each of the other two packages, thanks to second connectors of the carrier boards involved.

This approach makes it easy to add or remove packages, which can easily be grafted onto existing partitions. Partitions can, in turn, easily be reconfigured in software, thanks to the flexibility provided by software-define arrays.

In one or more embodiments, a first one of the packages is connected to a second one of the packages of the array, via second connectors of the carrier boards of such packages, and the second one of the packages is controlled by or via the processing unit of the first one of the packages.

Preferably, the software-defined array further comprises a chassis, in which each of the mass storage devices packages is compactly encased, side by side.

In one or more embodiments, the array comprises two subsets of mass storage device packages, wherein resources of packages of a second one of the subsets are controlled by or via one or more controller boards of one or more packages of a first one of the subsets.

Preferably, the chassis comprises a power supply unit opposite to one or more mass storage devices packages, which comprise, each, a limited number of mass storage devices compared with other packages of the array to accommodate the power supply unit in the chassis.

In one or more embodiments, the array comprises height mass storage devices packages, including six packages of fourteen mass storage devices and two packages of ten mass storage devices, the latter packages comprising a limited number of mass storage devices to accommodate the power supply unit in the chassis.

According to yet another aspect, the invention is embodied as a software-defined array of mass storage devices packages, comprising two or more mass storage devices packages, wherein the mass storage devices packages are configured as partitions of the array, each of the partitions involving at least one of the packages. Each of the packages comprises a structure that comprises a stack of two or more mass storage devices and a carrier board. The storage devices are of same dimensions and have, each, a form factor so as to have two opposite main surfaces, whereby the mass storage devices are superimposed in a stacking direction perpendicular to their main surfaces. Each of the mass storage devices of the stack is mounted on the carrier board, perpendicularly thereto, so as to be superimposed along said stacking direction. Each package further comprises a controller board mounted on top of the stack, aligned therewith, the controller board comprising first connectors, wherein the controller board has a form factor so as to have two opposite main surfaces, the latter vis-à-vis main surfaces of the more mass storage devices of the stack, and wherein a maximal dimension of any of the main surfaces of the controller board is less than or equal to a maximal dimension of the structure, in any direction perpendicular to said stacking direction. In addition, and for each of said packages, a carrier board comprises second connectors connecting the mass storage devices of the stack to the first connectors of the controller board, so as to allow control of the mass storage devices by said controller board. The second connectors of the carrier board are connected to second connectors of a carrier board of another one of the packages of the array.

Mass storage devices packages and software-defined arrays of such packages embodying the present invention will now be described, by way of non-limiting examples, and in reference to the accompanying drawings.

### BRIEF DESCRIPTION OF THE SEVERAL VIEWS OF THE DRAWINGS

FIG. 1 is a top view of a software-defined array of mass storage devices packages arranged side-by-side in a chassis, according to an embodiment of the invention;

FIG. 2 represents a logical overview of an array such as depicted in FIG. 1, wherein the array exhibits five partitions. The last three packages are configured as extension partitions, as involved in embodiments of the invention;

FIG. 3 depicts a carrier board design, according to an embodiment of the invention;

FIG. 4 shows a controller board, involving a processing unit, according to an embodiment of the invention;

FIG. 5 depicts a controller board, configured as an expander board (without any processing unit), according to an embodiment of the invention; and

FIG. 6 illustrate the connectivity of neighboring packages, wherein one of the packages involve the controller board of FIG. 4, while the connected package comprises the expander board of FIG. 5, according to an embodiment of the invention.

The accompanying drawings show simplified representations of devices or parts thereof, according to one or more embodiments of the invention. Technical features depicted in the drawings are not necessarily to scale. Similar or functionally similar elements in the figures have been allocated the same numeral references, unless otherwise indicated.

### DETAILED DESCRIPTION OF EMBODIMENTS OF THE INVENTION

The following description is structured as follows. First, general illustrative embodiments and high-level variants are described (sect. 1). The next section addresses more specific illustrative embodiments and technical implementation details (sect. 2).

### 1. General Illustrative Embodiments and High-Level Variants

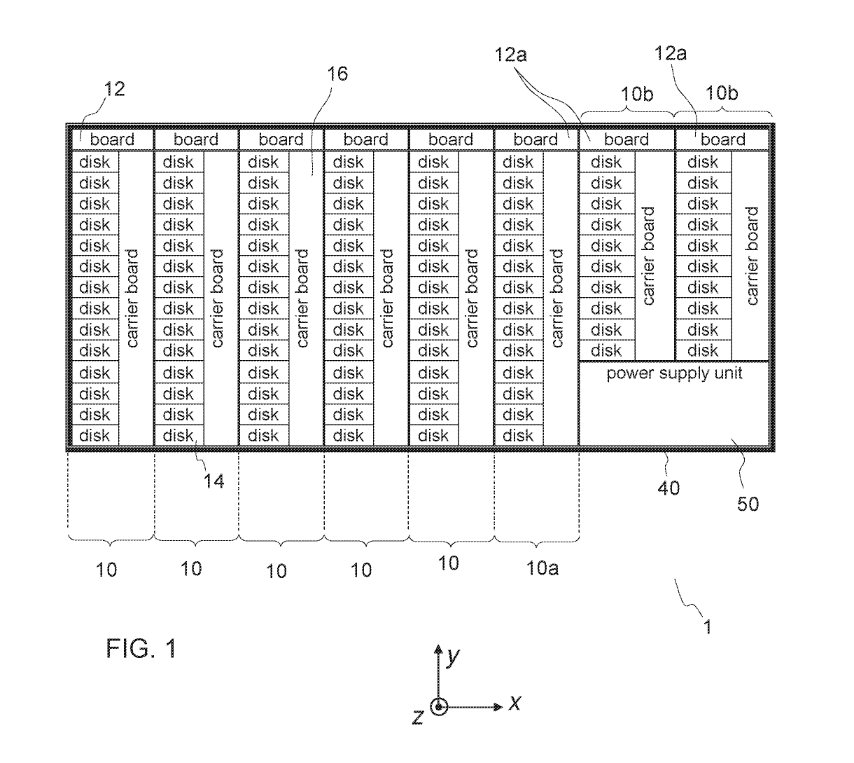

In reference to FIGS. 1-6, an aspect of the invention is first described, which concerns a mass storage devices package 10, 10a, 10b. Such a package can be used in a software-defined array such as depicted in FIG. 1. Software-defined arrays concern another aspect of the invention, which is discussed later in detail.

The present mass storage devices package notably comprises a structure that includes a stack of two or more mass storage devices 14. A mass storage device is for instance a hard disk drive, an optical drive, or a solid-state drive. The various devices 14 involved in each package preferably are of the same type.

As schematically illustrated in FIG. 1, the storage devices 14 of a given stack have all the same (or substantially the same) dimensions. They notably have similar form factors. Each storage device 14 exhibits two opposing main surfaces. Such surfaces are, for example, each, parallel to the (x, z) plane. The storage devices 14 are superimposed along the stacking direction y, e.g., the direction perpendicular to their main surfaces, or to their average plane, which is parallel to the (x, z) plane, to form a stack.

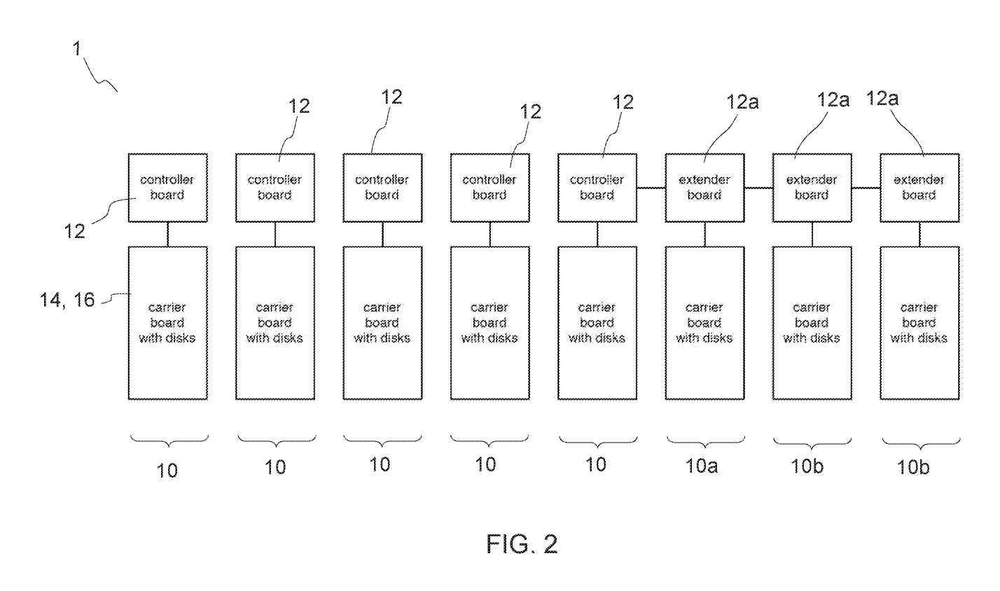

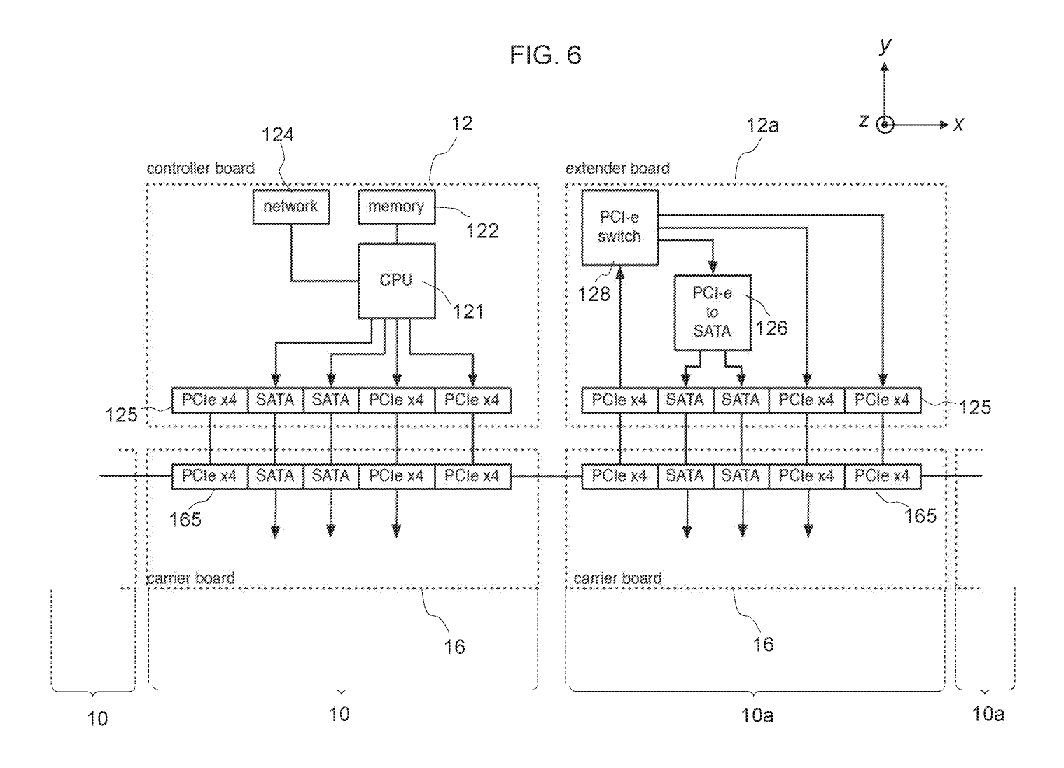

As better seen in FIG. 2 or 6, each package further comprises a controller board 12, 12a. The controller board is mounted on top of the stack, aligned therewith. The controller board 12, 12a comprises first connectors 125, which may implement one or more computer bus interfaces. These connectors 125 notably connect to the mass storage devices 14 of the stack, so as to allow control of the mass storage devices 14 by (or via) the controller board.

The controller board 12, 12a too has a form factor; i.e., it exhibits two opposing main surfaces, which are opposite to (i.e., face-to-face with) the main surfaces of the more mass storage devices 14 of the stack. A maximal dimension of (any of) the main surfaces of the controller board 12, 12a is less than or equal to a maximal dimension of the structure that comprises the stack (and possibly other components, see below), in any direction (x, z) perpendicular to said stacking direction y.

In the present approach, the controller board 12, 12a extends essentially in a plane (x, z) perpendicular to the stacking direction y, i.e., a plane parallel to the extension plane of the storage devices 14. The constraint otherwise imposed to the controller board 12, 12a, in terms of alignment and dimensions with respect to the structure of stacked storage devices 14, results in that the lateral footprint of the package (in a plane perpendicular to said stacking direction) is essentially determined by the structure, rather than by the controller board 12, 12a. That is, the controller board does not project over contours of the structure, laterally. In other words, the controller board does not form any substantial overhang above said structure, which would otherwise impact the lateral footprint of the package. Laterally compact packages are thereby obtained, which can be paired, to form a dense arrangement.

In particular, such packages can be used as modular packages, e.g., in a software-defined array 1 that will be described later. In one or more embodiments such as described below, each package 10, 10a, 10b may for instance be laterally connected to one or more neighboring packages via carrier boards thereof. This yields advantageous expansion capabilities. All the more, partitions of a software-defined array 1 of such packages can flexibility be configured.

The controller board 12, 12a can be an independent controller board, i.e., having one or more processing units, or an expander board (e.g., having no or little processing capability, beyond input/output (I/O) processing). Still, resources 14 of an expander board 12a may be managed by another partition, involving at least one other mass storage devices packages 10, i.e., a package having a board 12 with processing capability. In each case, the controller board 12, 12a is a hardware device that interfaces with the stack of mass storage devices 14.

The connectors 125 shall typically comprise host bus adapters that implement one or more computer bus interfaces, wherein the interfaces are configured to connect the mass storage devices 14 of the stack to the host bus adapters, e.g., via counterpart adapters on the carrier board 16.

A host bus adapter (HBA) is a circuit board and/or integrated circuit adapter that provides input/output (I/O) processing and physical connectivity between the host device (e.g., the controller board) and the connected devices (e.g., the mass storage devices 14). HBAs are usually contemplated as separate cards. In the present context, however, an HBA is typically considered to inherently form part of a controller. For instance, in one or more embodiments as described herein: a controller board may be equipped with a PCI-express controller, which inherently has an HBA already integrated therein. In other words, the terminology “HBA” as used herein refers more to the technical function of the HBA circuit than to the circuit itself, which is integrated in the controller's circuit. Moreover, a bus interface generally refers to the computer bus protocols, methods and hardware components that, altogether, allow to interface the connected devices, e.g., the mass storage devices 14 with, e.g., a processor of the controller board 12, 12a, via the host bus adapters. Such terms are, however, often used interchangeably in the literature. In one or more embodiments as discussed herein, one considers that “connectors” may comprise host bus adapters that implement one or more computer bus interfaces.

Referring now more specifically to FIGS. 1-3, the structure of the present mass storage devices packages 10, 10a, 10b may, in one or more embodiments, comprise a carrier board 16, onto which each of the mass storage devices 14 of the stack is transversally mounted; that is, the average plane of each device 14 (which typically are essentially planar objects) is transverse to the average plane of the carrier board (which typically is essentially planar too). As a result, the devices 14 are superimposed in direction y, i.e., the direction perpendicular to their main surfaces, as seen in FIG. 1. The storage devices 14 are preferably mounted perpendicularly to the carrier board 16.

In variants to FIG. 1 (which is a top view), the carrier boards may be mounted behind the devices 14 (they would therefore be not visible anymore in FIG. 1).

The carrier board 16 eases the assembly of the stacked devices 14 and forms part of the structures that otherwise comprises the stacked devices 14. Again, the maximal dimension of any of the main surfaces of a controller board 12, 12a is less than or equal to a maximal dimension of the structure (including the stack of devices 14 and the carrier board 16), in any direction x, z perpendicular to the stacking direction y of the device, so that packages 10-10b can be compactly paired, laterally, as illustrated in FIG. 1. In other words, this is the structure (comprising the stack of devices 14 and the carrier board 16) that essentially determine the lateral footprint of the packages, it being noted that such a structure may further comprise other components (in particular heat removal components, e.g., cooling plates, foils, comb, etc.).

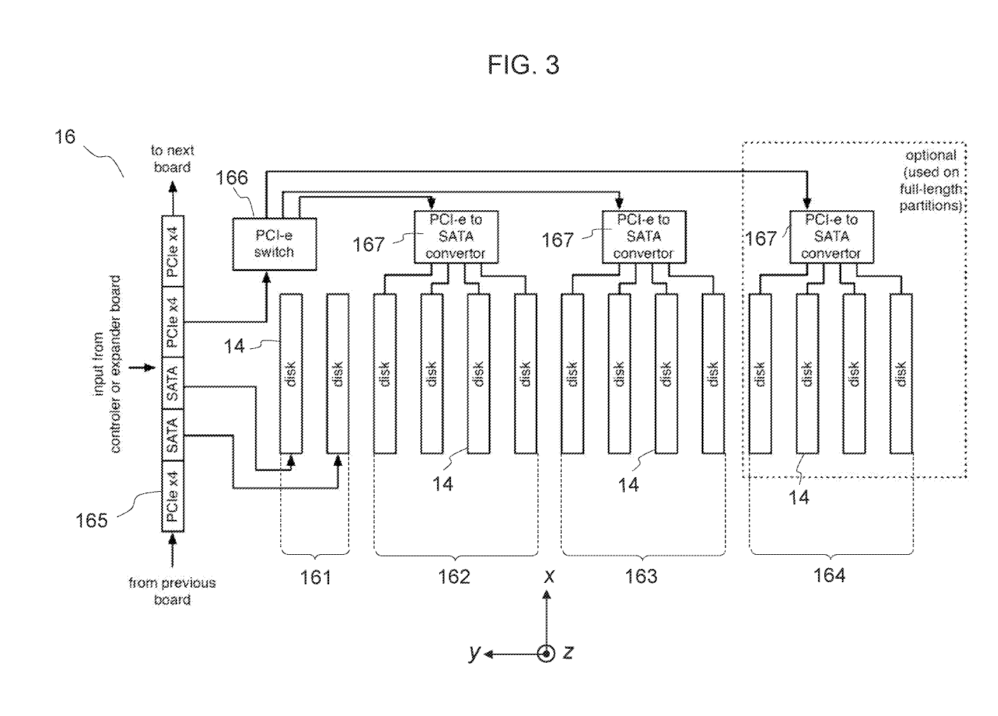

In addition, the carrier board may be leveraged to ease connection of the devices 14 to the controller board, as illustrated in FIG. 3 or 6. In this respect, and as for instance illustrated in depicted in FIG. 6, the carrier board 16 may, in one or more embodiments, comprise (second) connectors 165, which connect the mass storage devices 14 of the stack to the (first) connectors 125 of the controller board 12, 12a. To that aim, the connectors 125 and 165 have compatible interfaces, which may notably include SATA, PCIe, etc. For instance, the first connectors 125 (on the controller board) may comprises first PCIe adapters and first SATA adapters, while the second connectors 165 (on the carrier board side) may comprise second PCIe adapters and second SATA adapters, wherein the second adapters are connected to the first adapters.

In addition, the carrier board may be leveraged to ease connection to neighboring packages. That is, the connectors 165 of the carrier board 16 are preferably configured to allow connection thereof to connectors of a carrier board of another, similar package 10, 10a, 10b. More preferably, the connectors 165 of a carrier board 16 may be configured to allow connection thereof to two or more carrier boards 16 of respective packages 10, 10a, 10b. Connection to neighboring (e.g., adjacent) carrier boards are typically achieved thanks to PCIe computer bus interfaces, as assumed in FIG. 6.

As further seen in FIG. 6, connectors 125, 165 may actually involve several PCIe interfaces. More generally, connectors 125, 165 on the controller boards 12, 12a or the carrier boards 16 typically include several connectors (i.e., adapters and interfaces) that connect in a one-to-one mapping to counterpart connectors on other components 12, 12a, 16.

Accordingly, each of the packages 10-10b, or a subset thereof, may be connected to one or more neighboring packages in a software-defined array, via connectors 165 of their respective carrier boards 16, as illustrated in FIG. 6. As it can be realized, configuring connectors of the carrier boards 16 to allow direct connections to neighboring carrier boards allows to offload I/O processing from the controller board. Furthermore, this makes it possible to easily expand packages 10-10b in a software-defined array.

As further illustrated in FIGS. 3 and 6, the connectors 125 of the controller board 12, 12a may, in one or more embodiments, further comprise a SATA host bus adapter, which is specifically suited to connect to mass storage devices such as hard disk, optical and solid-state drives. One or more, e.g., a subset 161 of the mass storage devices 14 of the stack (for example the devices the closest to the board 12, 12a) may accordingly be directly connected to the SATA host bus adapter of the connectors 165, so as to be efficiently operated as flash memory by (or via) the controller board 12, 12a. For example, as illustrated in FIG. 3, the connectors 125 of the controller board 12, 12a may comprise two SATA host bus adapters. A subset 161 of two mass storage devices 14 of the stack can this be directly connected to the two SATA host bus adapters, respectively. Note, that the terminology “SATA host bus controller” is equivalent to “SATA controller”, for reasons stated earlier.

Each package 10, 10a, 10b shall typically comprise several storage devices 14. It may, for instance, include ten storage devices 14 (of same dimensions), or fourteen devices 14 in a full-length partition, as illustrated in FIG. 3. Such preferred numbers arise due to the fact that PCIe x4 connectors are preferably be used, whereas the subset 161 typically includes two devices 14, used a flash memory. More generally, each package may involve 4n+m device 14, where n denotes the number of subsets 162-164 of devices used for mass storage, and m refers to the number of devices used as flash memory. Each device 14 is connected, directly or indirectly, to host bus adapters of the connectors 125 of the controller board 12, 12a.

In particular, the carrier board 16 may further comprise a PCIe switch 166 (connected to a PCIe adapter of the carrier board 16) and one or more PCIe-to-SATA converters 167, each connected to the PCIe switch 166. This way, one or more subgroups 162-164 of storage devices 14 can be connected to the PCIe switch 166 via a respective one of the PCIe-to-SATA converters 167, as shown in FIG. 3.

As further illustrated FIG. 3, two PCIe-to-SATA converters 167 may be used to respectively connect two subgroups 162, 163 of mass storage devices 14 (each of the subgroups 162, 163 comprising four mass storage devices 14 of same dimensions), in a limited-length configuration. In a full-length partition, three PCIe-to-SATA converters 167 are used to connect three subgroups 162-164 of storage devices 14.

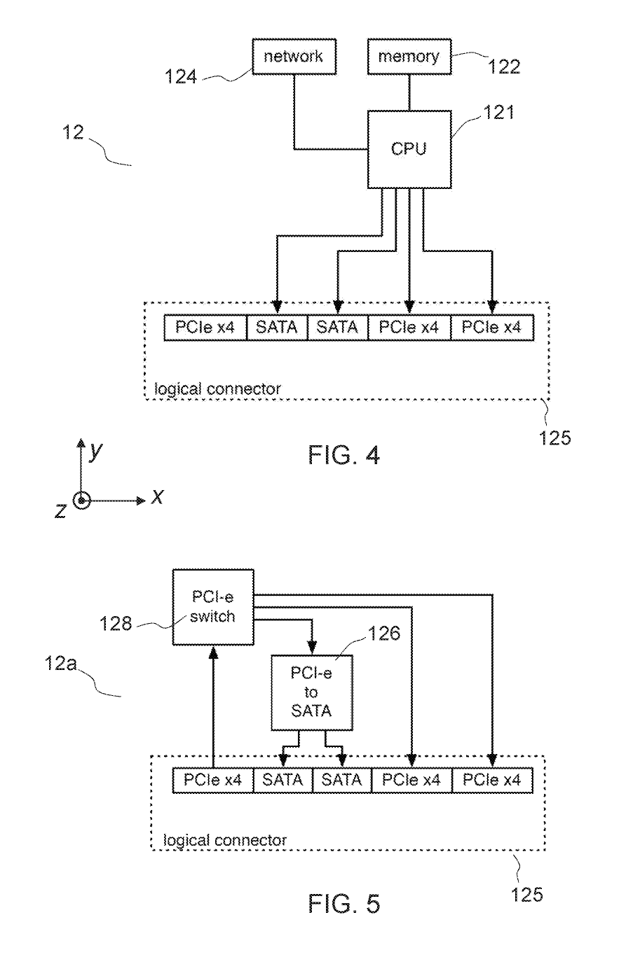

As previously stated, a controller board may provide independent control of the mass storage resources 14 of the stack it is mounted onto. For instance, as seen in FIGS. 4 and 6, the controller board 12 may comprise a processing unit 121. In such a case, the connectors 125 serve to connect the processing unit 121 to the mass storage devices 14 of the stack. If, on the other hand, the controller board is embodied as an expander board 12a (FIGS. 5, 6), then the controller board 12a may for instance comprise a switch 128 and connectors 125 connect the switch 128 to mass storage devices 14 of the stack. Yet, the switch 128 can be connected to a processing unit 121 of a controller board 12 of a neighboring package 10, such that resources of packages 10a, 10b may be controlled by the controller board 12 of this package 10.

Referring back to FIG. 1: according to another aspect, the invention can be embodied as a software-defined array 1 of mass storage devices packages 10, 10a, 10b. Basically, such an array 1 comprises two or more mass storage devices packages 10, 10a, 10b, such as described above. The packages 10, 10a, 10b may be configured as partitions of the array 1. Each partition involves at least one package 10 (having an independent controller board 12), and possibly other packages 10a, 10b (also referred to as expansion partitions, without substantial processing capabilities). In addition, a partition may involve expansion partitions 10a, 10b, wherein expander boards 12a are controlled by independent boards 12. For example, in FIG. 2, five (independent) partitions are provided. The last partition involves four packages 10-10b, including a package 10 with an independent board 12 and three expansion partitions 10a, 10b, relying on expander boards 12a connected to the sole independent controller board 12. The expander boards 12a are preferably connected from carrier board to carrier board, rather than being each directly connected to that board 12, due at least in part to the connectivity provided by the carrier boards, in one or more embodiments such as discussed earlier in reference to FIG. 3.

As described earlier in reference to FIGS. 1-3, each package 10, 10a, 10b of the array 1 preferably comprises a carrier board 16, with each of the storage devices 14 mounted transversally thereon and stacked along direction y, to ease the assembly of the devices. More preferably, connectors 165 of one or more of the carrier boards 16 may, each, connect the devices 14 of a respective stack to connectors 125 of a respective controller board, to allow control by (or via) this controller board 12 (or 12a).

In addition, one or more of the packages 10 shall preferably connect, each, to one or more neighboring packages, by leveraging the connectivity of the carrier boards 16, e.g., thanks to PCIe interfaces provided by connectors 165 thereof.

As stated earlier, the design of the packages 10-10b allow for modularity. A new package can, for instance, easily be grafted onto an existing partition, which can, in turn, easily be reconfigured in software, thanks to the flexibility provided by software-define arrays. For instance, referring back to FIG. 6: in one or more embodiments, the software-defined array 1 of mass storage devices packages may involve at least one package 10, connectable to each of the two adjacent package 10, 10a, thanks to PCIe x4 connectors on the carrier board 16. A package may, in turn, allow connection from a previous package to a further package, and so on. In an array 1, some packages 10 include a controller board 12 with processing capability (other than for I/O processing), while others 10a, 10b are part of an expansion partition, and therefore only need an expansion board 12a. Yet, resources of expansion packages 10a, 10b can be controlled by or via controller boards 12 of the packages 10.

Note, that the partitions can be configured independently from the actual locations of the packages in the array 1. Still, expander boards are preferably mounted side by side and consecutively, as assumed in FIG. 1.

As further illustrated in FIG. 1, the array 1 may typically comprise a chassis 40, in which the mass storage devices packages 10, 10a, 10b are compactly encased, side by side. In one or more embodiments, a power supply unit 50 is encased in the chassis 40. Because of compactness, the power supply unit 50 may be arranged opposite to one or more of the packages 10b. In such a case, the opposite packages 10b may comprise a limited number of mass storage devices 14 compared with other packages 10a, 10b of the array 1, in order to accommodate the power supply unit 50 in the chassis 40. For example, providing 2 subsets 162, 163 of devices 14 (instead of three in a full-length configuration as in FIG. 3), allows to save enough space to lodge a power supply unit 50 opposite two adjacent packages 10b.

In one or more embodiments relying on standard disks 14 and chassis, particularly compact arrangements may be achieved using height adjacent packages 10, 10a, 10b, including six packages 10, 10a of fourteen disks 14 and two packages 10b of ten disks 14, the latter reduced to accommodate the power supply unit in the chassis.

The above embodiments have been succinctly described in reference to the accompanying drawings and may accommodate a number of variants. Several combinations of the above features may be contemplated. For example, referring to FIG. 6, preferred embodiments of software-defined arrays 1 involve two or more mass storage devices packages 10, 10a, 10b configured as partitions of the array 1, wherein each of the partitions involves at least one package 10-10b. Each package comprises a structure with a carrier board and a stack of mass storage devices 14 (of same dimensions). The devices 14 are mounted perpendicularly on the carrier board 16, so as to be superimposed in a direction y perpendicular to their main surfaces. A controller (or expander) board 12, 12a is mounted on top of each stack, aligned therewith. Each controller board 12, 12a has a form factor; its main surfaces are opposite (i.e., face to face with) main surfaces of the storage devices 14. A maximal dimension of the controller board 12, 12a is less than or equal to the maximal dimension of the structure in a plane perpendicular to the stacking direction y. A carrier board 16 of each package comprises second connectors 165 connecting mass storage devices 14 of this package to first connectors 125 of the controller board of that same package, so as to allow control of the devices 14 by (or via) said controller board. In addition, connectors 165 of one or more of the carrier boards are connected to connectors 165 of one or more other carrier boards 16 (i.e., of other packages). This way, dense arrays of packages can be obtained, which allow offloading I/O processing from the boards 12, while allowing flexibility in partitioning the array.

Other specific embodiments are contemplated, an example of which are described in the next section.

### 2. Specific Illustrative Embodiments

Embodiments described in this section rely on a 4U enclosure, housing a software defined storage platform that can utilize a total of 104 disks, partitioned into 8 independent systems. Yet, as it may be realized, the platform can be partitioned into any n systems, nε[2; 8]. Furthermore, such embodiments make it possible to expand the number of accessible disks in a system, by exploiting an extensible PCI-e tree with SATA termination.

For example, assume a 4U system which is partitioned into a total of 8 partitions (or rows), including six full-length packages 10 and two limited-length packages 10a, 10b, as in FIG. 1. Each partition can be either independent 10 (which makes it fully independent of the other rows) or can be an expansion partition 10a, 10b, in which case its resources are managed by another partition; see FIG. 2.

As illustrated in FIG. 3, full-length partitions support fourteen drives 14, whereas half-length partitions support ten drives. The number of drives are limited due to the rack dimensions chosen. Yet, the present design is extensible, such that higher number of drives per partition may be achieved with different dimensions of the rack.

In order to ease the assembly, the drives 16 are connected to a carrier board 16. In addition to drives, each partition could either contain a single controller board 12, or an expander board 12a. A partition that contains an expander board is referred to as an expansion partition. Its resources are then controlled from the connected partition that contains an (independent) controller board, as depicted in FIG. 2. Each carrier board 16 contains connectors to attach a controller or an expander board. In addition, the carrier boards 16 contain connectors 165 to connect them to adjacent packages, e.g., via the immediate surrounding carrier boards 16 (FIG. 3).

For the purpose of building a low-power system, a controller 12 may comprise units such as a PowerPC processor 121, memory 122, network connection 124, connectors 165, e.g., including two PCI-e connectors and two SATA connectors. The latter two are used to connect to the carrier board 16 (FIG. 4). Here, “PCI-e” refers to a PCI-e x4 connection. An expander board 12a (FIG. 5) is a specialized board that contains logic to connect to a carrier board 16, as well as to another expander board 12a or a controller board 12.

To make the assembly simpler, the connections to another expander board or a controller board are routed via the carrier board 16 (depicted on FIG. 3). The expander board contains PCI-e switches 128 that split incoming PCI-e signal into a part that goes to the PCI-e to SATA converter 126 that further controls two disks (subset 161) on the carrier board 16, and two other PCIe parts. The first part is routed to the carrier board 16 to control the rest of the disks 14 in the package, while the other part is routed via a PCIe connector to the next carrier board 16. The expansion capabilities of the system are achieved through connections between carrier boards 16, as depicted in FIG. 6. Interestingly, PCI-e signal coming from the CPU 121 on the controller board 12 is routed via connectors 125, 165 between the controller board 12 and the carrier board 16, and from there onto the next carrier board. There, this signal passing via the PCIe connector between a carrier board 16 and the expander board 12a enters into a PCI-e switch 128, and is similarly propagated further.

While the present invention has been described with reference to a limited number of illustrative embodiments, variants and the accompanying drawings, it will be understood by those skilled in the art that various changes may be made and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims. In addition, many other variants than explicitly touched above can be contemplated. For example, the package may, in embodiments, comprise additional components, such as heat removal foils, to remove heat generated by the devices 14, e.g., via a heat sink (not explicitly shown, but implied).

What is claimed is:

1. A mass storage devices package, comprising:
a structure comprising a stack of two or more mass storage devices of same dimensions, each having a form factor including two opposite main surfaces, the mass storage devices superimposed in a stacking direction perpendicular to their main surfaces; and
a controller board mounted on top of the stack, aligned therewith, the controller board comprising connectors connecting to the mass storage devices of the stack, so as to control the mass storage devices, wherein the controller board has a form factor so as to have two opposing main surfaces, the latter opposite main surfaces of the more mass storage devices of the stack, and wherein a maximal dimension of any of the main surfaces of the controller board is less than or equal to a maximal dimension of the structure, in any direction perpendicular to said stacking direction.

2. The mass storage devices package according to claim 1, wherein
the structure further comprises a carrier board, wherein each of the mass storage devices of the stack is mounted transversally on the carrier board so as to be superimposed along said stacking direction.

3. The mass storage devices package according to claim 2, wherein:
said connectors of the controller board are first connectors; and
said carrier board comprises second connectors connecting the mass storage devices of the stack to said first connectors, said first and second connectors having at least one common computer bus interface.

4. The mass storage devices package according to claim 3, wherein
said second connectors are configured to allow connection thereof to a carrier board of another mass storage devices package, the latter also according to claim 3, by implementing a common computer bus interface.

5. The mass storage devices package according to claim 4, wherein
said second connectors are configured to allow connection thereof to carrier boards of other mass storage devices packages, each of said other mass storage devices packages also according to claim 3.

6. The mass storage devices package according to claim 5, wherein
said second connectors comprise one or more PCIe computer bus interfaces.

7. The mass storage devices package according to claim 1, wherein
the connectors of the controller board comprises a SATA host bus adapter, and
at least one of the mass storage devices of the stack is connected to said SATA host bus adapter, so as to be operated as flash memory by or via the controller board.

8. The mass storage devices package according to claim 7, wherein:
the stack comprises at least three mass storage devices of same dimensions, each connected to host bus adapters of said connectors of the controller board; and
the connectors of the controller board comprises two SATA host bus adapters, and two of the mass storage devices of the stack are connected to said two SATA host bus adapters, respectively, so as to be operated as flash memory by or via the controller board.

9. The mass storage devices package according to claim 7, wherein
the stack comprises ten or more of said mass storage devices of same dimensions, each connected to host bus adapters of said connectors of the controller board.

10. The mass storage devices package according to claim 3, wherein:
the first connectors comprises a first PCIe adapter and the second connectors comprises a second PCIe adapter, the latter connected to the first PCIe adapter;
the carrier board further comprises:
a PCIe switch, connected to the second PCIe adapter; and
one or more PCIe-to-SATA converters, each connected to the PCIe switch, and
one or more subgroups of mass storage devices of the stack are connected, each, to said PCIe switch via a respective one of the PCIe-to-SATA converters.

11. The mass storage devices package according to claim 10, wherein
the package comprises two PCIe-to-SATA converters and two subgroups of mass storage devices, each of the subgroups comprising four mass storage devices of same dimensions.

12. The mass storage devices package according to claim 10, wherein
the package comprises three PCIe-to-SATA converters and three subgroups of mass storage devices, each of the subgroups comprising four mass storage devices of same dimensions.

13. The mass storage devices package according to claim 1, wherein
the controller board comprises a processing unit, said connectors connecting said processing unit to the mass storage devices of the stack.

14. The mass storage devices package according to claim 1, wherein
the controller board comprises a switch, said connectors connecting said switch to the mass storage devices of the stack, said switch connectable to the processing unit of a controller board of a mass storage devices package according to claim 13.

15. A software-defined array of mass storage devices packages, comprising:
a plurality of mass storage devices packages, each of at least two of the mass storage devices packages comprising:
a structure comprising a stack of two or more mass storage devices of same dimensions, each having a form factor including two opposite main surfaces, the mass storage devices superimposed in a stacking direction perpendicular to their main surfaces; and
a controller board mounted on top of the stack, aligned therewith, the controller board comprising connectors connecting to the mass storage devices of the stack, so as to control the mass storage devices, wherein the controller board has a form factor so as to have two opposing main surfaces, the latter opposite main surfaces of the more mass storage devices of the stack, and wherein a maximal dimension of any of the main surfaces of the controller board is less than or equal to a maximal dimension of the structure, in any direction perpendicular to said stacking direction;
wherein the mass storage devices packages are configured as partitions of the array, wherein each of said partitions involves at least one of the packages.

16. The software-defined array of mass storage devices packages according to claim 15, wherein the structure in each of said at least two mass storage devices packages further comprises a carrier board, wherein each of the mass storage devices of the stack is mounted transversally on the carrier board so as to be superimposed along said stacking direction.

17. The software-defined array of mass storage devices packages according to claim 16, wherein in each of said at least two mass storage devices packages:
said connectors of the controller board are first connectors; and
said carrier board comprises second connectors connecting the mass storage devices of the stack to said first connectors, said first and second connectors having at least one common computer bus interface.

18. The software-defined array of mass storage devices packages according to claim 17, wherein in two of said at least two mass storage devices packages, said second connectors are configured to allow connection thereof to a carrier board of another mass storage devices package by implementing a common computer bus interface, and wherein one of said at least two mass storage devices packages is connected to the other one of said at least two mass storage devices packages by implementing said common computer bus interface.

19. The software-defined array of mass storage devices packages according to claim 18, wherein the array comprises three mass storage devices packages, wherein one of the three mass storage device packages is configured such that said second connectors allow connection thereof to carrier boards of other mass storage devices packages, and wherein said one of the three mass storage device packages is connected to each of the other two of the three mass storage devices packages via the second connectors thereof.

20. The software-defined array of mass storage devices packages according to claim 15, wherein
the array comprises two mass storage devices packages, wherein in a first one of the two mass storage device packages, the controller board comprises a processing unit, said connectors connecting said processing unit to the mass storage devices of the stack, and the controller board in a second one of the two mass storage devices packages comprising a switch, said connectors connecting said switch to the mass storage devices of the stack, said switch connectable to the processing unit of a controller board of another mass storage devices package, and wherein
said second one of the two mass storage device packages is connected to the first one of the two mass storage devices packages via the second connectors thereof, and said second one of the two mass storage devices packages is controlled by or via the processing unit of the first one of the two mass storage devices packages.

21. The software-defined array of mass storage devices packages according to claim 15, further comprising
a chassis, in which each of said two or more mass storage devices packages is compactly encased, side by side.

22. The software-defined array according to claim 21, comprising:
a first subset of mass storage device packages, each of the first subset of mass storage device packages being configured such that the controller board comprises a processing unit, said connectors connecting said processing unit to the mass storage devices of the stack; and
a second subset of mass storage device packages, each of the second subset of mass storage device packages being configured such that the controller board comprises a switch, said connectors connecting said switch to the mass storage devices of the stack, said switch connectable to the processing unit of a controller board of a mass storage devices package of the first subset;
wherein resources of the mass storage device packages of the second subset are controlled by or via one or more controller boards of respective one or more mass storage device packages of the first subset.

23. The software-defined array according to claim 22, wherein
the chassis comprises a power supply unit opposite to one or more mass storage devices packages, which comprise, each, a limited number of mass storage devices compared with other packages of the array, so as to accommodate the power supply unit in the chassis.

24. The software-defined array according to claim 23, wherein
the array comprises height mass storage devices packages, including six packages of fourteen mass storage devices and two packages of ten mass storage devices, the latter to accommodate the power supply unit in the chassis.

25. A software-defined array of mass storage devices packages, comprising:
two or more mass storage devices packages, wherein the mass storage devices packages are configured as partitions of the array, each of the partitions involving at least one of the packages, and wherein each of the packages comprises:
a structure comprising:
a stack of two or more mass storage devices of same dimensions, each having a form factor including two opposite main surfaces, the mass storage devices superimposed in a stacking direction perpendicular to their main surfaces; and
a carrier board, wherein each of the mass storage devices of the stack is mounted on the carrier board, perpendicularly thereto, so as to be superimposed along said stacking direction, and
a controller board mounted on top of the stack, aligned therewith, the controller board comprising first connectors, wherein the controller board has a form factor including two opposite main surfaces, the latter vis-à-vis main surfaces of the more mass storage devices of the stack, and wherein a maximal dimension of any of the main surfaces of the controller board is less than or equal to a maximal dimension of the structure, in any direction perpendicular to said stacking direction,
and wherein, for each of said packages:
a carrier board of said each of said packages comprises second connectors connecting the mass storage devices of the stack to the first connectors of the controller board of said each of said packages, so as to allow control of the mass storage devices by said controller board of said each of said packages; and
said second connectors of the carrier board are connected to second connectors of a carrier board of another one of said packages.
